(19) United States
(12) Patent Application Publication
(10) Pub. No.: US 2025/0195178 A1
(43) Pub. Date: Jun. 19, 2025

(54) ORTHOPEDIC APPLIANCE

(71) Applicant: Felix LIAO, Falls Church, VA (US)

(72) Inventor: Felix LIAO, Falls Church, VA (US)

(21) Appl. No.: 19/070,506

(22) Filed: Mar. 4, 2025

Related U.S. Application Data
(63) Continuation of application No. 17/346,742, filed on Jun. 14, 2021, now abandoned.
(60) Provisional application No. 63/110,663, filed on Nov. 6, 2020.

(51) Int. Cl. A61C 7/08

(52) U.S. Cl. CPC A61C 7/08

(57) ABSTRACT

An orthopedic appliance including: a base plate, a middle section, a left section, a right section, a dental clasp, a labial bow, an orthodontic spring and an expansion screw. The base plate includes a middle section having a top-front face, a bottom-front face adjacent to the top-front face, a bottom-rear face adjacent to the bottom-front face, and a rear face adjacent to each of the bottom-rear face and the top-front face, wherein the bottom front face includes a ledge which is substantially orthogonal to the primary plane such that the ledge may engage the lower front teeth of a wearer of the appliance.

### CROSS-REFERENCE TO RELATED APPLICATIONS

This application is a Continuation Application of, under 35 U.S.C. § 121, and claims priority to, under 35 U.S.C. § 121, U.S. Non-Provisional application Ser. No. 17/346,742, entitled ORTHOPEDIC APPLIANCE, by Dr. Felix Liao filed on Jun. 14, 2021. This invention claims priority, under 35 U.S.C. § 120, to the U.S. Provisional Patent Application No. 63/110,663 to Dr. Felix Liao filed on Nov. 6, 2020, which is incorporated by reference herein.

### BACKGROUND OF THE INVENTION

### Field of the Invention

The present invention relates to orthopedic appliances, specifically to maxillary appliances for redevelopment of deficient maxilla.

### Description of the Related Art

In the related art, it has been known to use orthopedic and orthodontic appliances to straighten patients' teeth and to correct jaw movements, including in cases where there are problems related to deficient maxillary development and the associated crowding and malocclusion. These appliances are sometimes difficult and time consuming to design and construct by the clinician, which may lead to errors in the final product. The appliances also sometimes deliver very slow and highly unpredictable results for the patients, which may cause significant discomfort or pain to the patient. Accordingly, the appliances sometimes require constant and drastic changes, modifications, and updates to enable the appliance to get the teeth and jaws of the patient to the desired outcome.

In the case of deficient maxillary development in adults, a patient may have symptoms of Impaired Mouth Syndrome. Impaired Mouth Syndrome is a term coined in 2017 (ref. Liao) to include medical, dental, and mood symptoms stemming from a structurally impaired mouth. Features of a structurally impaired mouth can include but not limited to dental malocclusion, teeth crowding, high palatal vault, clicking/popping/locking jaw joints, teeth grinding, persistent dental sensitivities, gum recession, one dental trouble after another, including fractured teeth, root canals, bone loss, failed implants dentally. Medical signs and symptoms of Impaired Mouth Syndrome can include those related to upper airway obstruction/deficiency: cardiovascular disease, high blood pressure, heart attack, stroke, heart failure, GERD, chronic fatigue, depression, anxiety, brain fog, chronic/recurring pain in neck, shoulders, back, and beyond, as well as the overweight and diabetes from overeating to escape the chronic stress of oxygen deficiency.

A structurally impaired jaw is generally one that failed to thrive during formative years. Chronic hypoxia, pain, fatigue, and premature degeneration of teeth and vital organs such as the brain and heart is a recurring theme in patients with Impaired Mouth Syndrome, especially where left undiagnosed for prolonged periods.

Some improvements have been made in the field. Examples of references related to the present invention are described below in their own words, and the supporting teachings of each reference are incorporated by reference herein:

U.S. Pat. No. 4,026,023, issued to Fischer, discloses an improved closed flap spring for orthodontic appliances used in orthodontic treatment of a patient, including a wire fashioned in the shape of a T, having a vertical portion and a horizontal portion, the vertical portion having a pair of spaced tag portions at its lower end for processing or attaching to the orthodontic appliance, a pair of spaced parallel arm portions as extensions of the tag portions forming the upper end of the vertical portion of the T, a pair of rounded loop portions, one of the loop portions extending generally horizontally outward from one of the arm portions in one direction and the other loop portion extending generally horizontally outward from the other arm portion in the opposite direction, and a bridge portion interconnecting the loop portions, the loop portions and bridge portion forming the horizontal portion of the T, which horizontal portion is free to engage and control the directional movement of a tooth.

U.S. Pat. No. 5,002,485, issued to Aagesen, discloses an orthopedic appliance for correcting Class II malocclusions which comprises a frontal portion configured to engage the mandibular and maxillary frontal arches and first and second side portions, posterior to the frontal portion, each configured to engage at least some of the maxillary molars. A universal screw assembly interconnects the frontal portions and the first and second side portions and operate to independently adjust the lateral spacing of the side portions from one another and the anterior-posterior spacing of the frontal portion from the side portions. The appliance is expanded in stages to maximize the utilization of corrective lower jaw movements which result from securing the appliance in the patient's upper mouth.

U.S. Pat. No. 7,314,372, issued to Belfor et al., discloses a method and apparatus for changing the form of the jaw and facial bones of an adult patient that did not develop fully during childhood. The method utilizes a device having a plate body with an expansion screw device that fits within the mouth of the patient, flap springs that project from the plate body and an overlay extending from the plate body. The device is placed within the mouth of the patient so that the overlay is in a position between at least two opposing teeth. In this position the flap springs press against selected teeth that are out of alignment in order to urge those teeth back into place. This force on the teeth causes the jawbone to expand to accept the teeth in their proper position(s). Also, the device is arranged such that the opposing teeth contact the overlay during swallowing, which causes the patient's facial muscles to intermittently pull on the facial bones. This intermittent application of force to the facial bones causes these bones to further develop toward a symmetrical appearance of the face and the positioning of out of place teeth/tooth into proper position. The device can be adjusted by small motors under the control of a microprocessor located on the body plate based on readings from sensors on the flap springs.

U.S. Pat. No. 7,887,324, issued to Singh, discloses in a preferred embodiment of the present invention, an osteogenetic-orthodontic appliance, device, system, and method optimizes craniofacial homeostasis by means of a 3-D axial spring that influences the patient's genome and thereby addresses problems existing primarily within the mid-facial region, as well as the other contiguous regions. Growth and development of the craniofacial structures can be influenced by foundational (skeleto-dental) correction in concert with functional (myo-spatial) correction, according to the genome of a particular patient by means of the method and systems of the present invention.

U.S. Pat. No. 8,435,031, issued to Hang, discloses a new and useful orthodontic clasp that is more resistant to breakage, and when in use is unlikely to separate from its associated orthodontic appliance should breakage occur, comprising two metal wires crossed at an angle and held together with a weld/solder joint, said weld/solder joint having four wire segments extending from said two metal wires crossed at the weld/solder joint, two of said wire segments adjacent and longer in length and two of said wire segments adjacent and shorter in length, said four wire segments each having a clasp wire bend.

U.S. Pat. No. 8,192,196, issued to Singh, discloses one embodiment of an invention consisting of a non-rigid, epigenetic-pneumopedic appliance comprising a wire-type framework supporting bow, bands, brackets or a clasp. The appliance includes active elements adapted to provide brief doses of cyclic forces to induce sutural osteogenesis. The active elements are vibrational, ultrasonic or oscillatory components. The epigenetic-pneumopedic appliance cooperates with an actuator or other expansion mechanism, such as suture spring, that straddles the midline of the appliance. The appliance further includes tooth-contacting material having high-elasticity, such as pre-formed alloys that form 3-D axial springs, which adapt to the long axis of the palatal/lingual surfaces of the teeth. The appliance also includes a plurality of micro-screws 2 along with driving means preferably consisting of either an electrical, ultrasonic (vibrational) meso-motor, or, alternatively, a micro-motor. The epigenetic-pneumopedic appliance may be used with directional bite props.

U.S. Patent Application Publication No.: 2005/0186524, by Abolfathi et al., discloses systems and methods for making an arch expander for a patient by scanning the patient's dentition; fabricating an appliance adapted to be positioned between posterior teeth and a palatal arch, the appliance having first and second movable portions; and providing an expander between the first and second portions of the appliance.

The inventions heretofore known suffer from a number of disadvantages which include: causing pain, disrupting sleep, causing very slow improvements to jaw size, causing unpredictable lower jaw growth, causing lethargy, being expensive, being difficult to use and maintain, being uncomfortable, being difficult and time consuming to size, design, and construct, and not reducing, resolving or mitigating pain. In particular, dental malocclusion with upper incisors angle below 110 (low normal of Sassouni cephalometric analysis) has been resistant to the intended actions of axial springs. The result is very slow or lack of progress, or non-resolution of mandibular entrapment that characterizes Impaired Mouth Syndrome.

What is needed is an orthopedic-orthodontic appliance that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available docking and mooring devices. Accordingly, the present invention has been developed to provide satisfactory placement for the entrapped mandible so that it is in a more physiologically de-compressed position.

There may be an apparatus for correcting Impaired Mouth Syndrome which may include a base plate having a u-shaped top surface in a primary plane, the base plate configured to engage the maxillary arch, the base plate may further include a middle section having a top-front face, a bottom-front face which may be adjacent to the top-front face, a bottom-rear face which may be adjacent to the bottom-front face, and a rear face which may be adjacent to each of the bottom-rear face and/or the top-front face, wherein the bottom front face may include a ledge which may be substantially orthogonal to the primary plane such that the ledge may engage a front tooth of a wearer of the appliance, a left section coupled to the middle section, and a right section coupled to the middle section, opposite the left section, a dental clasp which may be rigidly connected to the base plate and may be shaped to engage the maxillary teeth, an expansion screw which may be coupled between one or more of the middle section, the left section, and the right section, the ledge may be formed by recording a desired resting position for a lower jaw of a patient by which may be by use of a construction bite and then creating a ledge in the middle section that may correspond with a position of the patient's lower front teeth while in the desired resting position, the ledge may be a left-to-right stepwise ledge configured to receive a plurality of teeth, and may include a groove along a bottom region thereof, the middle section may consist of a single resinous material, the ledge may be an indentation in the bottom-front face, there may be a second ledge which may be on a bottom-front of either the left or right section, the dental clasps may include hooks which may attach to an oral face mask, and the first base plate may include a myofunctional tongue bead.

There may also be a method for creating a groove in an orthopedic appliance, which may include placing a pressure sensor into an ear of a patient, opening and closing the jaw of the patient while assessing whether the jaw joint is pushing on the pressure sensor, moving the jaw of the patient until the jaw joint is no longer pushing on the pressure sensor when the jaw opens and closes, recording the position where the jaw joint of the patient no longer presses on the pressure sensor when the jaw opens and closes, and making a ledge in an orthopedic appliance, the ledge positioned so that when the teeth of the patient are resting in the groove, the jaw is in the recorded position, thereby forming an indexed ledge, the step of moving the jaw of the patient may include moving the jaw forward and downward, the step of recording the position of the jaw may include utilization of a construction bite, the orthopedic appliance may be a maxillary appliance, the step of making a ledge may include the ledge being positioned so that when the mandibular front teeth of the patient are resting in the ledge, the jaw is in the recorded position, and the pressure sensor may be a finger.

There may also be a method of treating Impaired Mouth Syndrome of a patient, which may include determining a first desired mandibular position, recording the first desired mandibular position, providing a maxillary appliance having a mandibular tooth ledge positioned to match the first desired mandibular position when a tooth of the patient rests against the indexed mandibular tooth ledge, and placing the maxillary appliance within a mouth of the patient so that the patient is able to rest a tooth against the mandibular tooth ledge, the maxillary appliance may include a middle section, which may be flanked by left and/or right sections, and the indexed mandibular tooth ledge may be on the middle section, there may be a step of adjusting the maxillary appliance so that the mandibular front teeth may rest within the ledge and the jaw may be held in a position wherein the jaw joint may no longer press on the ear canal and may be trained to remain in that position when the device is removed, the step of adjusting may occur after determining a second desired mandibular position after a period of treatment at the first desired mandibular position, and the indexed mandibular tooth ledge may include a groove at the base thereof.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawing(s). It is noted that the drawings of the invention are not to scale. The drawings are mere schematics representations, not intended to portray specific parameters of the invention. Understanding that these drawing(s) depict only typical embodiments of the invention and are not, therefore, to be considered to be limiting its scope, the invention will be described and explained with additional specificity and detail through the use of the accompanying drawing(s), in which:

FIG. 1 is a bottom perspective view of an orthopedic appliance, according to one embodiment of the invention;

FIG. 2 is a cross-sectional view of an orthopedic appliance, according to one embodiment of the invention;

FIG. 3 illustrates an orthopedic appliance in use by a patient, according to one embodiment of the invention;

FIG. 4 is a flowchart of a method of creating a ledge in an orthopedic appliance, according to one embodiment of the invention; and

FIG. 5 is a flowchart of a method of treating Impaired Mouth Syndrome of a patient, according to one embodiment of the invention.

### DETAILED DESCRIPTION OF THE INVENTION

For the purposes of promoting an understanding of the principles of the invention, reference will now be made to the exemplary embodiments illustrated in the drawing(s), and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to an “embodiment,” an “example” or similar language means that a particular feature, structure, characteristic, or combinations thereof described in connection with the embodiment is included in at least one embodiment of the present invention. Thus, appearances of the phrases an “embodiment,” an “example,” and similar language throughout this specification may, but do not necessarily, all refer to the same embodiment, to different embodiments, or to one or more of the figures. Additionally, reference to the wording “embodiment,” “example” or the like, for two or more features, elements, etc. does not mean that the features are necessarily related, dissimilar, the same, etc.

Each statement of an embodiment, or example, is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The features, functions, and the like described herein are considered to be able to be combined in whole or in part one with another as the claims and/or art may direct, either directly or indirectly, implicitly or explicitly.

As used herein, “comprising,” “including,” “containing,” “is,” “are,” “characterized by,” and grammatical equivalents thereof are inclusive or open-ended terms that do not exclude additional unrecited elements or method steps. “Comprising” is to be interpreted as including the more restrictive terms “consisting of” and “consisting essentially of.”

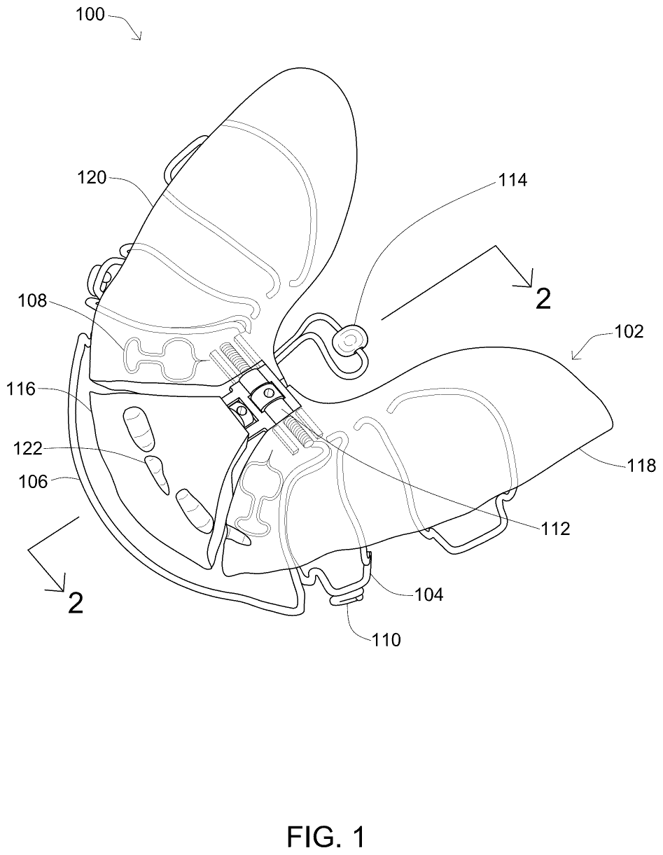

FIG. 1 is a bottom perspective view of an orthopedic appliance, according to one embodiment of the invention. There is shown an orthopedic appliance 100 configured to couple to maxillary arch, including a base plate 102 having a middle section 116 coupled between a right section 118 and a left section 120. The illustrated middle and left sections 116, 120 include a plurality of indexed ledges (which may be adjusted/smoothed by the attending doctor as appropriate to customize the indexed ledges to the particular patient) 122 disposed at custom locations on a bottom-front face thereof that serve as a resting location for the front mandibular teeth of the particular user for which the orthopedic appliance is fitted and/or formed. Indexed ledges are ledges disposed within the base plate that are indexed to the shape and position of the lower incisors of the patient. In particular, the indexed ledges are shaped and located so that the lower incisors of the patient may simultaneously rest on their associated ledge in a manner that places the lower jaw in a desired position with respect to the upper jaw and cranium.

The illustrated orthopedic appliance also includes a dental clasp 104 rigidly coupled to the base plate 102 (which may be on the upper molars or premolars), a labial bow 106 rigidly connected to the base plate 102, a flexible orthodontic spring 108 rigidly connected to the base plate 102, a hook 110 rigidly connected to the dental clasp 104, an expansion screw 112 functionally coupled to the base plate 102, and a myofunctional tongue bead 114 rigidly coupled to the base plate 102. Advantageously, the user may wear the orthopedic appliance 100 and rest his/her mandibular front teeth on the ledges of the base plate which has been observed by applicant to trigger significant mitigation or resolution of impaired mouth syndrome in combination with a bone building diet to more fully and quickly resolve mandibular entrapment as a root cause of symptoms of Impaired Mouth Syndrome.

The illustrated base plate 102 includes a middle section 116, a right section 118 coupled to the middle section 116, and a left section 120 coupled to the middle section 116. The middle section 116 includes a top-front face, a bottom-front face adjacent to the top-front face, a bottom-rear face adjacent to the top-front face, and a rear face adjacent to each of the bottom-rear face and the top front face. It is noted that since the appliance couples to the roof of the mouth of the user, the top surface thereof is the surface that comes into contact with, or is otherwise oriented towards, the roof of the mouth, while the bottom surface is oriented towards the oral cavity.

The illustrated base plate 102 is U-shaped and formed to snugly fit within a specific patient's mouth, engaging the maxillary arch and the crown of two or more maxillary teeth. However, as the base plate must fit within the mouth of the particular user, the particular shape of any particular base plate 102 will vary among those various shapes and designs which fit within that particular patient's mouth. The base plate 102 is made of a single hardened resinous material, however, other embodiments may be made of any number of strong and/or stiff nontoxic materials such as but not limited to: resins, metals, hard or soft plastics, ceramics, and the like and combinations thereof.

In other embodiments, there may be a second orthopedic appliance, which may be used in conjunction with the first orthopedic appliance 100 and may including one or more of a base plate, a dental clasp rigidly coupled to the base plate, a labial bow rigidly connected to the base plate, an orthopedic spring rigidly connected to the base plate, a hook rigidly connected to the dental clasp, an indexed ledge to support a decompressed mandibular posture, but without an expansion screw. This second embodiment has its own indications, such as absence of necessary natural teeth in implant-supported dentures or full dentures, or in cases where the patient does not desire expansion or alter jaw structure for any reason.

The third orthopedic appliance redevelops the mandibular arch, and may be used in concert with the first (top) orthopedic appliance 100. The second orthopedic appliance will not include ledges for the top teeth to rest on as the top teeth generally already protrude further than the bottom teeth in an entrapped mouth. Depending on the lower arch form, degree of crowding of lower front teeth, and whether the patient has habitual snoring, certain hooks and additional springs may be added as needed. The third orthopedic appliance helps the mandibular arch grow, side-to-side, similar to growth experienced by the maxillary arch during use of the first appliance 100.

As illustrated, the middle section 116 includes a plurality of ledges 122, the illustrated ledges 122 are generally orthogonal to the primary plane such that the ledges 122 may engage front bottom teeth of a wearer of the appliance. A ledge 122 is generally not shaped to trap or otherwise lock the front tooth in any position. Instead, it is a stable resting spot for the associated front tooth when the lower jaw of the patient is positioned so that the patient's lower jaw is in a desired resting position. The base plate in which the ledge 122 is disposed may have a bump of sufficient size to accommodate the desired vertical position for the lower teeth and mandible with respect to the maxillary teeth.

The illustrated plurality of ledges 122 may be described as a single left-to-right stepwise ledge configured to receive a plurality of teeth. The ledge(s) 122 may also be described as being grooves or indentations in the bottom-front face wherein the tooth is more constrained from movement in two or more directions. Depending on the shape of the patient's mouth, there may also be one or more ledges or grooves in the left section 120 or right section 118 of the base plate 102 (the illustrated example includes a ledge 122 at the front end of the right section 118). Alternatively, there may be two or more ledges on one or more of the left section 120, right section 118, and/or middle section 116.

The illustrated dental clasp 104 is partially enclosed within either the right section 118 or the left section 120 of the base plate 102, which helps secure the dental clasp 104 in place. The dental clasp 104 also has exposed sections that engage the maxillary teeth of the patient in order to keep the device securely within the patient's mouth, as well as assist in positioning the teeth and/or jaw of the patient.

The illustrated labial bow 106, in the form of an arch wire, is partially enclosed within the right section 118 and left section 120 of the base plate 102. This labial bow keeps the weight of the lip off to allow forward development of maxilla and movement of teeth. The labial bow 106 also has exposed sections to allow attending doctor the make necessary adjustments periodically as the maxilla (jaw and teeth) develops forward as a pre-requisite to liberate the mandible from entrapment.

The illustrated orthodontic spring 108 is partially enclosed within the right section 118 or the left section 120 of the base plate 102, which helps secure the orthodontic spring 108 in place. The orthodontic spring 108 also has exposed sections, including a head portion, which rests against the inside of the teeth of the patient. The amount of contact the orthodontic spring 108 has with the teeth of the patient may be changed by manipulating or bending the orthodontic spring 108 to further engage or disengage the teeth of the patient.

The illustrated hook 110 is generally soldered to the rest of the dental clasp 104 and may assist in attaching the orthopedic appliance 100 to a face mask or elastics as needed. The hook 110 may have a bulbous end to assist in retaining a strap or band hooked to it. In other embodiments, the hook 110 may be welded, crimped, wrapped or adhered to the dental clasp 104, or may be formed, drawn, extruded, cast, or molded with the rest of the dental clasp 104 as a single unit.

The illustrated myofunctional tongue bead 114 is partially enclosed within the right section 118 or left section 120 of the base plate 102, which helps secure the myofunctional tongue bead 114 in place. The myofunctional tongue bead 114 also has exposed sections, which includes a head around which a rotatable bead is placed, which may assist the patient to start positioning the tongue and swallowing in the correct pattern.

The illustrated dental clasp 104, labial bow 106, orthodontic spring 108, hook 110, and myofunctional tongue bead 114 are not connected to the middle section 116 in any way, however in other embodiments the dental clasp 104, labial bow 106, orthodontic spring 108, and/or hook 110 may be connected to the middle section 116 to provide structure, ease of use, and/or damage resistance to the middle section 116. Each of the dental clasp 104, labial bow 106, orthodontic spring 108, and hook 110 are each made of a single strand of stainless steel wire, however, other embodiments may include multiple strands of wire, all pieces made of a singular strand of wire, and/or each section may be made separately or together of any other number of strong and/or stiff nontoxic materials including but not limited to: resins, epoxies, metals, hard plastics, soft plastics, and the like and combinations thereof. These materials may be plated, coated, or painted to assist with preventing corrosion, to enable the orthopedic appliance 100 to be placed in or removed from the mouth more easily, or to promote comfort and/or strength of the orthopedic appliance 100 when worn by the patient.

The illustrated expansion screw 112 is rigidly connected to each of the left, right, and middle sections, 120, 118, 116. The expansion screw 112 may be manually adjustable to control the separation distance of the sections from one another. The expansion screw 112 may be made of any number of strong and/or stiff nontoxic materials such as but not limited to: resins, epoxies, metals, hard plastics, and the like and combinations thereof. These materials may be plated, coated, or painted to assist with preventing corrosion and/or promoting the strength and/or comfort of the orthopedic appliance 100 worn by the patient.

In operation, the orthopedic appliance 100 is pressed into the mouth of the patient, with the dental clasp 104 and the labial bow 106 on the outside of the teeth and the majority of the base plate 102 on the inside and bottom of the teeth, the rest of the base plate 102 will rest on the crowns of the teeth of the patient. The dental clasp 104 and labial bow 106, having a bit of flexibility, will press up against the teeth and hold the appliance in place, and may also exert a bit of pressure on the teeth to rearrange and/or straighten them. The ledge 122 will give the lower teeth a stable place to rest, thereby assisting the patient with keeping the lower jaw in a desired position which creates desired jaw redevelopment.

In conjunction or alternatively to the ledge 122 modification, the expansion screw 112 may be turned to widen and/or lengthen the device, promoting further growth in combination with a bone building diet (e.g. plant greens, bone broth to serve as collagen precursors). The device may then be placed back into the patient's mouth until more growth has been observed. Once sufficient growth has been obtained where the ledge 122 or base plate 102 is no longer useful, a new device may be designed and created until the desired growth has been fully achieved.

In some embodiments, there may be an oral face mask attached to the hook 110 to further assist the orthopedic appliance 100 forward development of the maxilla to the desired position.

Advantageously, the orthopedic appliance 100 is an easy-to use and maintain appliance that that may be designed, created, and modified quickly, easily, and inexpensively, while also being very comfortable for an orthopedic appliance 100. This allows the orthopedic appliance 100 to rapidly, yet predictably, cause lower jaw growth without causing the patient to be uncomfortable or in undue pain. The orthopedic appliance 100 thereby is easier to use and is more likely to be worn by the patient, causing faster changes and greater success rates.

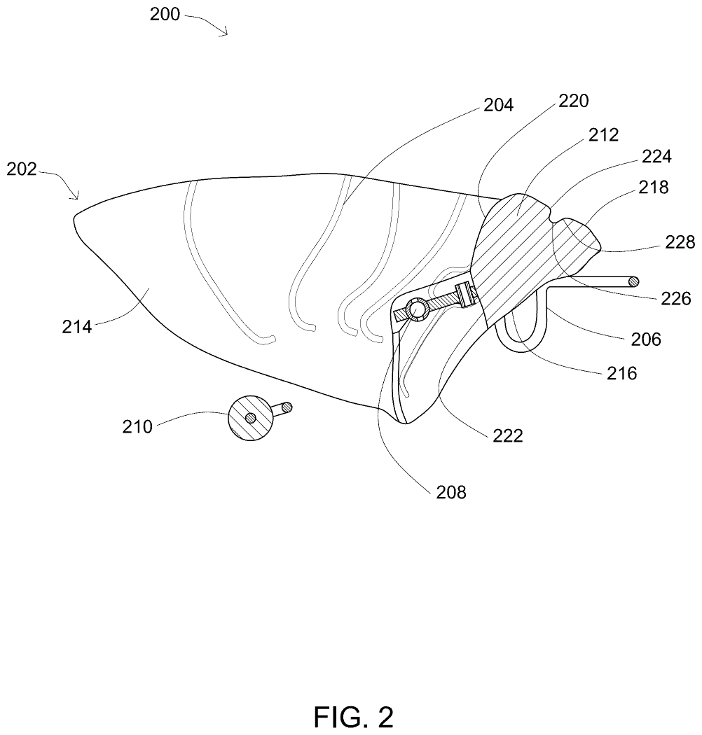

FIG. 2 is a cross-sectional view of an orthopedic appliance, according to one embodiment of the invention. There is shown an orthopedic appliance 200 including a base plate 202, a dental clasp 204, a labial bow 206, an expansion screw 208, and a myofunctional tongue bead 210.

As illustrated, the base plate 202 includes a middle section 212 and a right section 214 coupled to the middle section 212. The middle section 212 includes a top-front face 216, a bottom-front face 218 adjacent to the top-front face 216, a bottom-rear face 220 adjacent to the top-front face 216, and a rear face 222 adjacent to each of the bottom-rear face 220 and the top front face 216. The bottom-front face 218 includes a ledge 224 which acts as a resting spot for the mandibular teeth of a patient.

The illustrated ledge 224 is sufficiently high so that the mandibular teeth remain in front of the ledge 224 and do not slide over the ledge 224 when at rest. The ledge 224 also has groove 226 at the bottom thereof, which is deep and well-defined to enough to create a secondary ledge 228. The groove 226 and secondary ledge 228 allow the mandibular teeth of the patient to be held more securely in place while at rest.

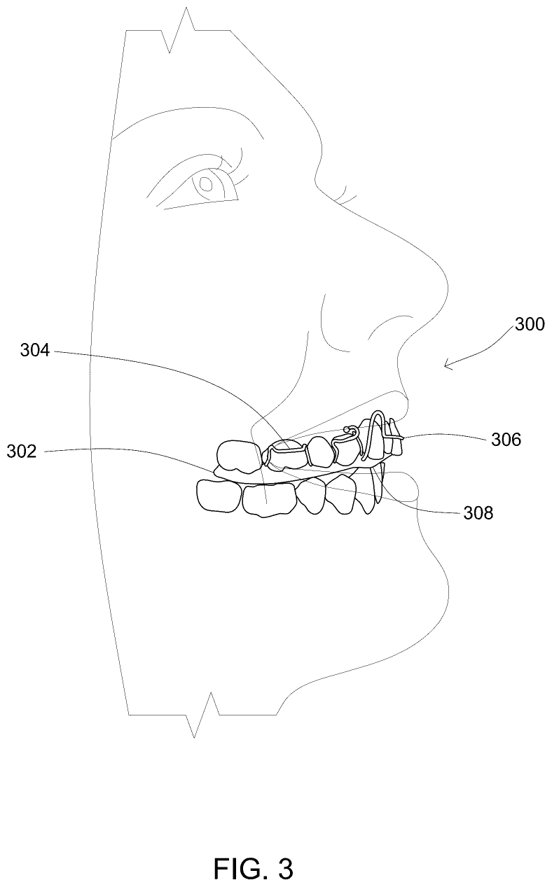

FIG. 3 illustrates an orthopedic appliance in use by a patient, according to one embodiment of the invention. There is shown an orthopedic appliance 300 resting within the maxillary arch of a patient, securely held in place by a base plate 302 fitted to the inside of the maxillary arch, and a dental clasp 304 and a labial bow 306 fitted around the teeth on the outside of the maxillary arch.

As illustrated, the base plate 302 includes a ledge 308 on the bottom front face of the base plate, wherein the front mandibular teeth are resting. The positioning of the front mandibular teeth on the ledge 308 is predetermined so that the jaw is shifted into a desired position which opens the airway and allows the jaw to grow and be reshaped properly. Additionally, the ledge allows the patient's body to align the upper and lower dental midlines—generally a necessary prerequisite to be free of head-neck-back pain naturally.

When the teeth are resting in or on the ledge in the predetermined position, the mandible glides physiologically both downward and outward, as well as centered compared to the existing pathological resting position. By centering and pulling the jaw of a patient forward and downward, an immediate result may be the tongue of the patient also being pulled forward and downward with the jaw, which may result in the tongue no longer crowding the airway of the patient, which opens up the airway and allows the patient to breathe easier and more efficiently.

Further, the opening up of the jaw caused by the new position of the jaw may allow the room necessary for the patient's jaw to grow or otherwise develop so that when the orthopedic appliance is removed, the patient's jaw has more room or remains in a better position. In either case, the volume inside the mouth of the patient is increased, so the patient's mouth does not seem so crowded. This may also allow the tongue to not invade the airway space at the rear of the mouth of the patient, resulting in an easier time breathing. It may also help the jaw open and close better or in a more desirable position, which may help reduce jaw clicking, jaw tightness, and other side effects from issues such as Impaired Mouth Syndrome and Temporomandibular Joint Syndrome, as well as may help square up the face and improve the aesthetic appeal of the jaw, jawline, and/or the face as a whole.

Applicant has also observed the correction of the jaw to improve posture and alignment of the neck and back, improve balance, correct malocclusion, improve teeth grinding, and help reduce or mitigate aches and pains such as occipital headaches and back pain.

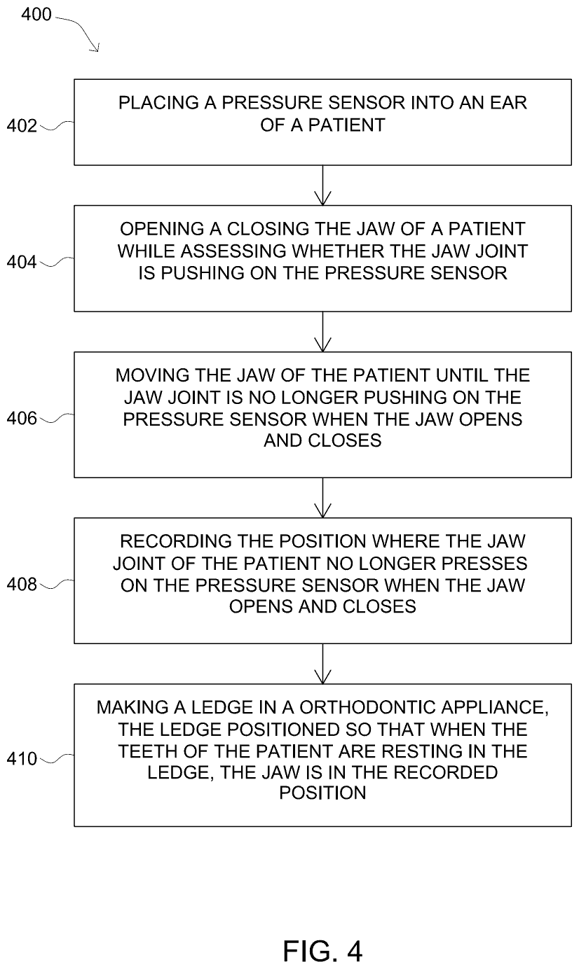

FIG. 4 is a flowchart of a method of creating a ledge in an orthopedic appliance, according to one embodiment of the invention. There is shown a method of creating a ledge in an orthopedic appliance 400 such that the ledge position and location is customized to the particular oral geometry and desired oral geometry as determined by a trained professional. The method includes positioning a pressure sensor into an ear canal of the patient, detecting mandibular pressure in the ear canal, adjusting the mandibular posture to remove such pressure, recording the position of the jaw wherein pressure is removed, and making a ledge in an orthopedic appliance that matches the recorded jaw position.

The illustrated method of creating a ledge in an orthopedic appliance 400 includes placing a pressure sensor into an ear of a patient 402. The pressure sensor may be a mechanical or electrical sensor, including but not limited to potentiometric, inductive, capacitive, piezoelectric, strain gauge, variable reluctance, and the like and combinations thereof. In other embodiments, the pressure sensor may be a finger rather than a mechanical or electrical device. When the finger is used the test is generally referred to as the “pinky test” wherein the pinky finger of the patient is inserted, pad forward, into the ear canal of the same patient so that the pad of the pinky finger may sense mandibular pressure expressed within the ear canal.

The illustrated method of creating a ledge in an orthopedic appliance 400 includes opening and closing the jaw of the patient while assessing whether the jaw joint is pushing on the pressure sensor 404. The clinician, patient, and/or a machine may close the patient's mandible into maximal intercuspation (prevailing bite) in determining whether there is pressure exerted against the sensor. In other embodiments, the mouth may be moved in any direction to determine if the jaw joint is exerting pressure on the pressure sensor.

The illustrated method of creating a ledge in an orthopedic appliance 400 includes moving the jaw of the patient (generally forward and down) until the jaw joint is no longer pushing on the pressure sensor when the jaw opens and closes 406. If the jaw joint is pushing on the pressure sensor, the jaw needs to be moved slightly forward and/or downward. Once the jaw is moved, the patient/professional may then recheck to see if there is still push back by the jaw joint on the pressure sensor.

The illustrated method of creating a ledge in an orthopedic appliance 400 includes recording the position where the jaw joint of the patient no longer presses on the pressure sensor when the jaw opens and closes 408. Once the jaw is in the position where the jaw joint is no longer pushing on the pressure sensor when the jaw opens and closes, the clinician uses a construction bite, or intermaxillary record, to record the first mandibular position. In other embodiments, the step of recording the position may be done with hand recording, photographs, x-ray, having the patient bite down on a device, an occlusal rim, and the like and combinations thereof.

The illustrated method of creating a ledge in an orthopedic appliance 400 includes making a ledge in an orthopedic appliance 410. In making a ledge in an orthopedic appliance 410, the ledge is created and positioned so that when the teeth of the patient are resting in the ledge, the jaw joint is in the decompressed (pinkie negative) position. The ledge is positioned so that when the mandibular front teeth of the patient are resting in the ledge, the jaw is in the recorded position.

Instead of determining the correct mandibular position with a sensor, the correct mandibular position may be determined by using a myo-monitor, by muscle testing (i.e. checking the deltoid muscles at various jaw positions to find a position of strength), by fluoroscopy of the jaw joint head to directly observe the condyle position, using a phonetic bite, by using neuromuscular registration, using a swallow bite, heart rate variability test, neuromuscular bite using a TENS device, and the like and combinations thereof.

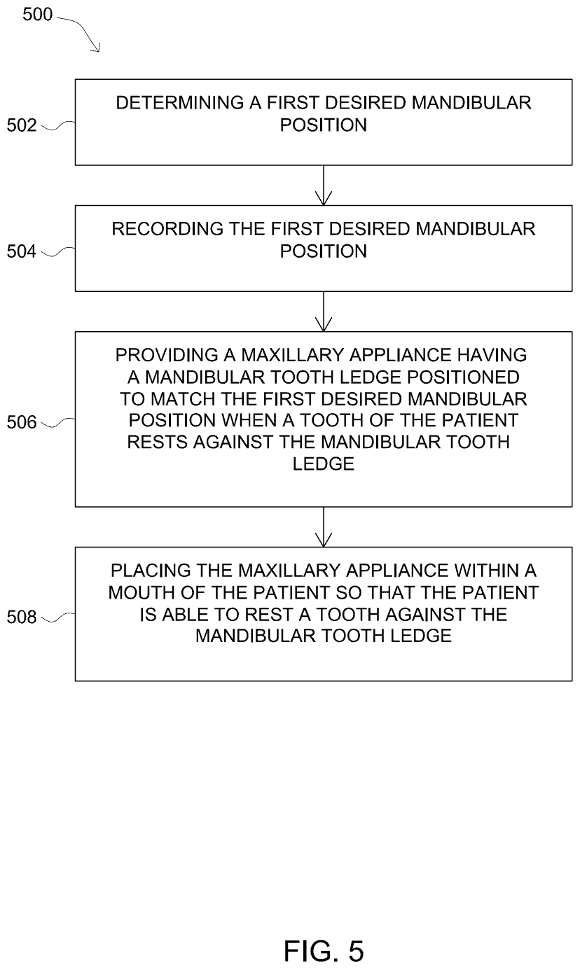

FIG. 5 is a flowchart of a method of treating Impaired Mouth Syndrome of a patient, according to one embodiment of the invention. There is shown a method of treating Impaired Mouth Syndrome of a patient 500.

The illustrated method of treating Impaired Mouth Syndrome of a patient 500 includes the step of determining a first desired mandibular position 502. In determining the first desired mandibular position 502, the doctor and/or patient places their pinky into the patient's ear and then opens and closes the jaw. If there is push back by the jaw joint head on the pinky when teeth are in maximal contact in the back teeth, it means that the mandible is entrapped to contribute to Impaired Mouth Syndrome, and thus will need to be moved slightly forward and downward. Once the jaw is repositioned, the doctor/patient may then recheck to see if there is still push back by the jaw joint head on the pinky. This process repeats until there is no pushback on the pinky inside the ear, at which point the jaw is in the first desired mandibular position.

In other embodiments, another finger or a finger of the clinician may be used instead of the patient's finger, or a pressure sensor may be used instead of a finger. Additionally, the clinician or a machine may open and/or close the patient's mouth, and the mouth may be moved in any direction to determine if the jaw joint head exerts pressure on the sensor. Furthermore, the jaw may be moved in any direction to determine the first mandibular position.

The illustrated method of treating Impaired Mouth Syndrome of a patient 500 includes the step of recording the first desired mandibular position 504. Once the jaw is in the first desired mandibular position, the clinician uses a construction bite, or other maxillary or intermaxillary record, to record the first mandibular position. In other embodiments, the step of recording the first desired mandibular position may be done with hand recording, photographs, x-ray, having the patient bite down on a device, an occlusal rim, and the like and combinations thereof.

The illustrated method of treating Impaired Mouth Syndrome of a patient 500 includes the step of providing a maxillary appliance having a mandibular tooth ledge 506. In providing a maxillary appliance having a mandibular tooth ledge 506, the appliance and ledge are positioned to match the first desired mandibular position when a tooth of the patient rests against the mandibular tooth ledge. This maxillary appliance may include one or more of a base plate, a dental clasp, a labial bow, and a myofunctional tongue bead one or more of which may be rigidly connected to the base plate and may engage the teeth of a patient, and also may include an expansion screw which may be rigidly connected to the base plate.

The illustrated method of treating Impaired Mouth Syndrome of a patient 500 includes the step of placing the maxillary appliance within a mouth of the patient 508. In placing the maxillary appliance within a mouth of a patient 508, the maxillary appliance is placed so that the patient may rest lower front teeth against the mandibular tooth ledge. The step of placing the maxillary appliance within a mouth of a patient 508 may be done by the patient, the clinician, and/or a third party.

In other embodiments, the method of treating Impaired Mouth Syndrome 500 may include the step of adjusting the maxillary appliance so that the mandibular front teeth rest within the ledge and the jaw is held in a position wherein the jaw joint no longer presses on the ear canal and is trained to remain in that position when the device is removed. The step of adjusting the maxillary appliance may occur after determining a second desired mandibular position after a period of treatment at the first desired mandibular position.

Applicant has seen improved health results when the use of the appliance is paired with a variety of other holistic health practices, one such non-limiting example being the appliance paired with a bone building diet to help the development of the jaw of the patient. For patients with airway obstruction, weight-loss diets or removals of certain foods, and example being using a keto diet, helps. This may be especially important if the patient has a swollen tongue from conditions such as hyperthyroidism. A few more non-limiting examples include breathing, walking, and posture training as well as hormonal therapy.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claims rather than by the foregoing description. All changes which come within the meaning and range of equivalency of the claims are to be embraced within their scope.

For example, although the orthopedic-orthodontic appliance is designed to promote the growth of the jaw and the mandibular and/or maxillary arch, the appliance may also be used to straighten and/or move teeth.

Additionally, the base plate may be formed, grooved, molded, and the like between one or more dental clasp to fit the curvature of the teeth of the patient. This prevents the teeth of the patient from incorrectly shifting due to resting on a non-confirming surface and allows the orthopedic appliance to have the dental clasps move or position the teeth. It also helps secure the device in a fixed portion of the mouth of the patient.

It is also envisioned that the base plate may be broken down into additional smaller sections to enable a clinician to have more control over the growth of the mouth of a patient. These additional sections may be connected with flexible wire and/or expansion screws to provide the ability to continuously adjust the positioning of the additional sections.

It is expected that there could be numerous variations of the design of this invention. An example is that the base plate consists of the middle section which may be without the expansion screw, allowing a patient to rest the jaw in the desired position and therefore to have the jaw trained to retain that position without shifting the rest of the teeth and/or jaw around. This may also be an inexpensive yet useful way to show patients the benefits of the device.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims. Further, it is contemplated that an embodiment may be limited to consist of or to consist essentially of one or more of the features, functions, structures, methods described herein.

What is claimed is:

1. An orthopedic appliance for correcting Impaired Mouth Syndrome, comprising:
a) a base plate having a u-shaped top surface in a primary plane, the base plate configured to engage the maxillary arch, including:
i) a middle section having a top-front face, a bottom-front face adjacent to the top-front face, a bottom-rear face adjacent to the bottom-front face, and a rear face adjacent to each of the bottom-rear face and the top-front face, wherein the bottom front face includes a ledge which is substantially orthogonal to the primary plane such that the ledge may engage a front tooth of a wearer of the appliance;
ii) a left section coupled to the middle section; and
iii) a right section coupled to the middle section, opposite the left section;
b) a dental clasp rigidly connected to the base plate and shaped to engage the maxillary teeth;
c) an expansion screw coupled between each of the middle section, the left section, and the right section.

2. The appliance of claim 1, wherein the ledge is formed by recording a desired resting position for a lower jaw of a patient by use of a construction bite and then creating a ledge in the middle section that corresponds with a position of the patient's lower front teeth while in the desired resting position.

3. The appliance of claim 1, wherein the ledge is a left-to-right stepwise ledge configured to receive a plurality of teeth.

4. The appliance of claim 1, wherein the ledge includes a groove along a bottom region thereof.

5. The appliance of claim 1, wherein the middle section consists of a single resinous material.

6. The appliance of claim 1, wherein the ledge is an indentation in the bottom-front face.

7. The appliance of claim 1, further comprising a second ledge on a bottom-front of either the left or right section.

8. The appliance of claim 1, wherein the dental clasp includes hooks to attach an oral face mask.

9. The appliance of claim 1, wherein the base plate includes a myofunctional tongue bead.

10. A method of creating an indexed ledge in an orthopedic appliance, comprising the steps of:
a) placing a pressure sensor into an ear of a patient;
b) opening and closing the jaw of the patient while assessing whether the jaw joint is pushing on the pressure sensor;
c) moving the jaw of the patient until the jaw joint is no longer pushing on the pressure sensor when the jaw opens and closes;
d) recording the position where the jaw joint of the patient no longer presses on the pressure sensor when the jaw opens and closes; and
e) making a ledge in an orthopedic appliance, the ledge positioned so that when the teeth of the patient are resting in the ledge, the jaw is in the recorded position, thereby forming an indexed ledge.

11. The method of claim 10, wherein the step of moving the jaw of the patient includes moving the jaw forward and downward.

12. The method of claim 10, wherein the step of recording the position of the jaw includes utilization of a construction bite.

13. The method of claim 10, wherein the orthopedic appliance is a maxillary appliance.

14. The method of claim 10, wherein the step of making a ledge includes wherein the ledge is positioned so that when the mandibular front teeth of the patient are resting in the ledge, the jaw is in the recorded position.

15. The method of claim 10, wherein the pressure sensor is a finger.

16. A method of treating Impaired Mouth Syndrome of a patient, comprising the steps of:
a) determining a first desired mandibular position;
b) recording the first desired mandibular position;
c) providing a maxillary appliance having an indexed mandibular tooth ledge positioned to match the first desired mandibular position when a tooth of the patient rests against the indexed mandibular tooth ledge; and
d) placing the maxillary appliance within a mouth of the patient so that the patient is able to rest a tooth against the indexed mandibular tooth ledge.

17. The method of claim 16, wherein the maxillary appliance includes a middle section, flanked by left and right sections and the indexed mandibular tooth ledge is on the middle section.

18. The method of claim 16, further comprising the step of adjusting the maxillary appliance so that the mandibular front teeth rest within the ledge and the jaw is held in a position wherein the jaw joint no longer presses on the ear canal and is trained to remain in that position when the device is removed.

19. The method of claim 18, wherein the step of adjusting occurs after determining a second desired mandibular position after a period of treatment at the first desired mandibular position.

20. The method of claim 16, wherein the indexed mandibular tooth ledge includes a groove at the base thereof.
